(19) United States
(12) Patent Application Publication
(10) Pub. No.: US 2026/0213977 A1
(43) Pub. Date: Jul. 23, 2026

(54) Offloaded Triggered Barriers

(71) Applicant: Hewlett Packard Enterprise Development LP, Spring, TX (US)

(72) Inventors: Naveen Namashivayam Ravichandrasekaran, Saint Paul, MN (US); Nathan L. Wichmann, Plymouth, MN (US)

(21) Appl. No.: 19/034,435

(22) Filed: Jan. 22, 2025

(51) Int. Cl. H04L 12/46; G06F 13/40; H04L 12/66

(52) U.S. Cl. CPC H04L 12/4633; G06F 13/4022; H04L 12/66; G06F 2213/0026

(57) ABSTRACT

Network interconnect-offloaded triggered operations are provided herein, in which triggered management is offloaded from local processing circuitry of compute blades to network interconnects used to intercouple the compute blades. A network interconnect may receive trigger condition data, confirm whether a condition is met, and initiate chained operations when the condition is met with a reduced number of PCIe crossings, causing improvements in overall system latencies.

### BACKGROUND

In the digital world, ever-increasing computer functionalities are available for access and use. With the increase in computer functionalities comes increased use of large volumes of data at increasingly higher speeds. With these increases come increased used of modern supercomputers able to process the large volumes of data based on multiple compute blades executing computing operations in parallel. These computing operations may be managed and executed via communications between processors of the compute blades.

### DRAWINGS

Features, aspects, and advantages of the present disclosure will become better understood when the following detailed description is read with reference to the accompanying drawings in which like characters represent like parts throughout the drawings, wherein:

FIG. 1 is diagram illustrating a system that includes compute blades, in accordance with aspects of the present disclosure;

FIG. 2 is a diagram illustrating a first triggered operation triggered by a local processor and a second triggered operation triggered by a remote processor, in accordance with aspects of the present disclosure;

FIG. 3 is a diagram illustrating an example network interconnect device that manages triggered operations on behalf of a host processor, in accordance with aspects of the present disclosure;

FIG. 4 is a flow diagram illustrating a process for implementing triggered operations of FIG. 2, in accordance with aspects of the present disclosure;

FIG. 5 is a flow diagram illustrating a computer-readable medium for implementing the triggered operations of FIG. 4, in accordance with aspects of the present disclosure;

FIG. 6 is a flow diagram illustrating a process for determining a networking structure that may be used with the triggered operations, in accordance with aspects of the present disclosure; and

FIG. 7 is a diagram illustrating a triggered operation performed by processors and network interconnect devices of a networking structure enabled through the process of FIG. 6, in accordance with aspects of the present disclosure.

### DETAILED DESCRIPTION

To perform the tasks of complex applications, modern supercomputers may include a cluster of multiple compute blades, and the compute blades may execute computing operations of the complex applications in parallel. Parallel execution of these computing operations may involve communication operations that move data associated with the computing operations between the compute blades as communication operations. These communication operations, also referred to herein as network operations, may be managed by a host processor of the compute blades. Managing the communication operations may involve the host processor receiving payload and/or acknowledge signals from other computing resources (e.g., other processors) associated with the operations. The host processor may couple to the other computing resources through couplings that use Peripheral Component Interconnect Express (PCIe) for communication. This may result in multiple PCIe crossings for communications between the host processor and remote processors, which introduces latency into management of the operations.

For example, in linear barrier operations, a host processor may manage the control path of numerous communication operations. With the host processor connected to the network interconnect device coupled using PCIe, the host processor managing the communication may wait to proceed with processing operations until receiving signals from each participating processor via the PCIe. Adding further latency, the host processor may respond to the respective signals with respective acknowledge signals via the PCIe to release respective processors from the linear barrier operation. Since these linear barrier operations use the host processor to manage the control path, signals may be transmitted across the PCIe. As a result, these communication operations may be computationally expensive and may incur substantial latency costs for the network.

Accordingly, the present disclosure generally relates to adapting communication operations to be managed by a network interconnect device as network-offloaded triggered operations. By using network triggered operations supported by the network interconnect device, latency and computation costs of the communication operations may reduce through reducing PCIe crossings that occur in association with such network operations.

In contrast to traditional host processor-managed communication operations, the present disclosure provides a solution that offloads control paths of the communication operations to a network interconnect device as network-offloaded triggered operations. This enables a network interconnect to manage the network operations without intervention from the host processor. More specifically, the present disclosure offloads trigger management from a host processor of a compute blade, also referred to herein as a compute blade device, to a network interconnect used to intercouple the compute blades. By doing so, a network interconnect may receive trigger condition data, determine whether a condition is met, and initiate one or more chained operations when the condition is met.

To elaborate, a network interconnect may include a hardware counter for one or more triggered list entries (TLEs) of triggered operations. The hardware counter may be incremented based on data from a processor of a compute blade (e.g., a local processor of a local compute blade, a remote processor of a remote compute blades). When the hardware counter reaches a trigger threshold, the network interconnect may cause the execution of the triggered operation. The triggered operation may involve the network interconnect incrementing the hardware counter, causing execution of other triggered operations of other TLEs chained with the original triggered operation. While the network interconnect manages the triggering of operations, the processor may exit an operation immediately after enqueuing results from the operation. The exiting of the processor may enable the processor to continue with other computing operations, reducing or eliminating the processor waiting to further manage the triggered operation chaining.

Network interconnect-offloaded operations are compatible with any suitable network topology, including tree topologies and all-to-all topologies, such as the dragonfly topology. An example network topology that may be used to implement the network interconnect-offloaded operations is a near-far tree structure. This tree structure may associate respective nodes to a process executed by respective compute blades. The tree structure may assign nodes to compute blades based on each parent node having two child nodes, where one of the child nodes has an index relatively near the parent node, and the other child node has an index equal to half a total distance between the compute blades included in the network. The total distance may refer to a physical distance, a logical distance, a temporal distance, or any suitable quantifiable distance indication. In particular, using both network interconnect-offloaded operations and the near-far tree structure may further improve efficiency of high-performance computing (HPC) operations within a group by reducing or eliminating bisectional or inter-group network communication patterns.

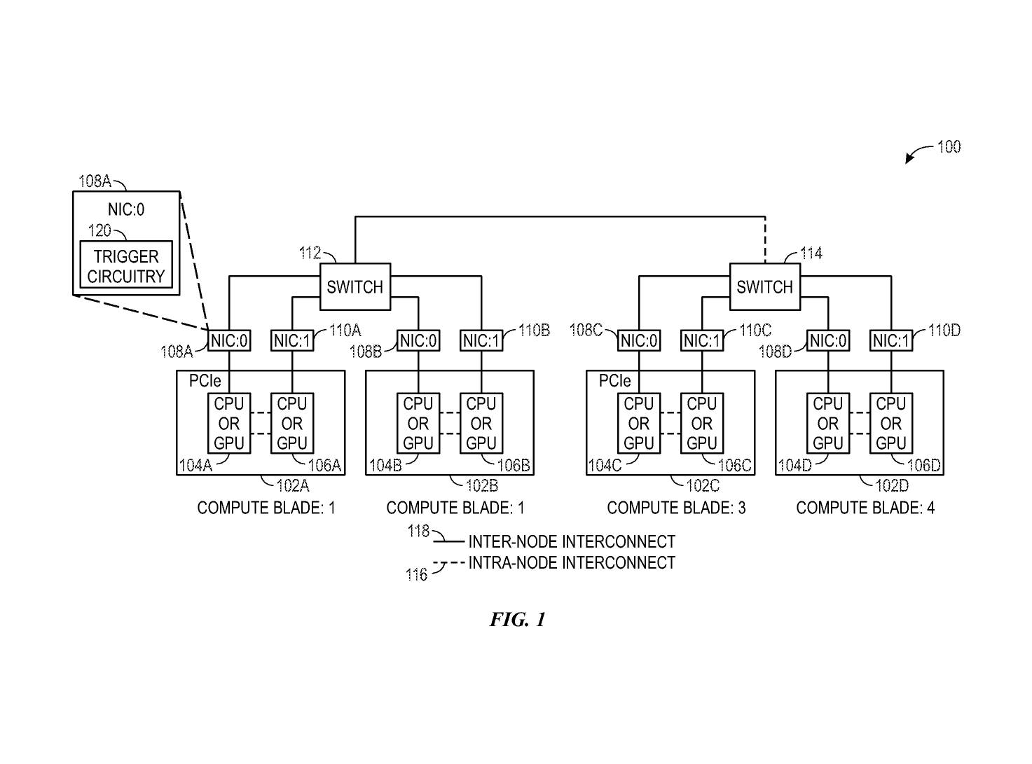

FIG. 1 is a diagram illustrating a computing system 100 that includes compute blades 102. The computing system 100 may include any suitable computing devices that may utilize data memory and/or storage, such as servers, desktop computers, laptop computers, tablet computers, cellular devices, wearable devices, and/or other computing devices.

A respective compute blade 102 may include one or more processors 104 and/or 106, which may include any combination of one or more central processing units (CPUs), one or more graphics processing units (GPUs), data processing units (DPUs), neural processing units (NPUs), one or more field programmable gate arrays (FPGA), one or more programmable logic devices (PLD), or other suitable processing resources. The one or more processors 104 and/or 106 may perform one or more computing operations. The illustrated example includes four compute blades 102 each including two processors 104 and/or 106. In other examples, the system 100 may include any suitable number of compute blades 102 (e.g., dozens, hundreds, or thousands of compute blades) each compute blade 102 may include any suitable number of processors of various types.

In addition to the processors 104 and/or 106, each compute blade 102 may include storage resources, networking resources, memory resources, or other resources used for an application of the system 100. For example, the one or more processors 104 and/or 106 may communicate with storage and/or memory, which may store programs or computer-readable instructions. Such programs or instructions executed by the one or more processors 104 and/or 106 may be stored in any suitable article of manufacture that includes one or more non-transitory and computer-readable media at least collectively storing the instructions or routines to perform various computing operations.

As illustrated, each compute blade 102 may use an intra-node interconnect 116 to facilitate communication within the compute blade (e.g., between processors 104 and/or 106 of the compute blade). The intra-node interconnect 116 may include, for example, a PCIe connection or other suitable data transfer connection. Each compute blade 102 may use an inter-node interconnect 118 to facilitate communication with other compute blades 102. The inter-node interconnect 118 may include and/or be used in conjunction with the network interconnect devices 108 and 110, the switches 112 and 114, and may include Ethernet connections, InfiniBand connections, or other suitable high-speed interconnects. In addition, the inter-node interconnect 116 may include a direct connection, a PCIe root complex, or another suitable connection that couples the processors 104 and/or 106 to respective network interconnect device 108 and 110. The network interconnect devices 108 and 110 may include, for example, switches, network interface cards, hubs, gateways, routers, or the like. The network interconnect devices 108 and 110 may facilitate data transmission (e.g., data packet transmission) between the processors 104 and/or 106 of different compute blades 102. Further, trigger circuitry 120 of the network interconnect devices 108 and 110, which may include, for example, triggered list entry (TLE) hardware and counter hardware, may manage triggered operations of the processors 104 and/or 106. For example, the trigger circuitry 120 of the network interconnect devices 108 and 110 may receive trigger condition data from the processors 104 and/or 106 with an indication of a processing operation, determine whether a trigger condition is met, and initiate the processing operation when the condition is met. Additionally, while the illustrated example includes multiple network interconnect devices 108 (e.g., one for each of the processors 104 and/or 106), in some examples, the functions of the network interconnect devices 108 may be performed by fewer network interconnect devices (e.g., a single network interconnect device) than the number of the processors 104 and/or 106. Further, each of the network interconnect devices 108 and 110 may communicate with other network interconnect devices 108 and 110 via the inter-node interconnect 118.

The inter-node interconnect 118 may couple network switches 112 and 114 to respective network interconnect devices 108 and 110. The network switches 112 and 114, also referred to herein as switch devices, may manage network traffic between the network interconnect devices 108 and 110, and thus between the processors 104 and/or 106. For example, the network switch 112 may route data packets and/or signals received from the network switch 114 to the network interconnect device 108A, 110A, 108B, or 110B based on, for example, a destination media access control (MAC) address of the received data packet and/or signal. Similarly, the network switch 112 may route a data packet and/or signal received from the network interconnect device 108A to another network interconnect device 110A, 108B, or 110B or to an appropriate network switch based on characteristics of the received packet and/or signal.

Computing operations performed by the processors 104 and/or 106 may be a smaller part of a more complex task performed by the system 100. For example, one or more of the processors 104 and/or 106 may compute respective submatrices as part of a matrix multiplication operation used by the system 100 for a machine learning or graphics processing application. A network topology may structure the computing operations and may be implemented through physical couplings, logical couplings, or a combination of both. While one possible topology of the system 100 is shown for illustrative purposes, the system 100 may include any suitable network topology, such as an all-to-all topology.

As part of the computing operations, the processors 104 and/or 106 may perform communication operations to communicate via network interconnect devices 108 and/or 110 and network switches 112 and/or 114. The processors 104 and/or 106 may communicate signals, which may include statuses, acknowledge signals, data, or the like. Any suitable type of operation may be used to move the signal. For example, the move operation may be an atomic operation, like an atomic increment or an atomic decrement, or a remote direct memory access (RDMA) send-receive operation, or an RDMA put-get style of asynchronous operations. The type of signaling and the type of move operation may depend on the programming model being implemented via the processors 104 and/or 106.

The processors 104 and/or 106 may perform processing operations in parallel and synchronized with processing operations of other processors 104 and/or 106 among the compute blades 102, which may be referred to as synchronized parallel processing operations. To perform synchronized parallel processing operations, the operations of the processors 104 and/or 106 may be coordinated through networking operations that may be chained together. Such networking operations may be coordinated by the network interconnect devices 108 and/or 110.

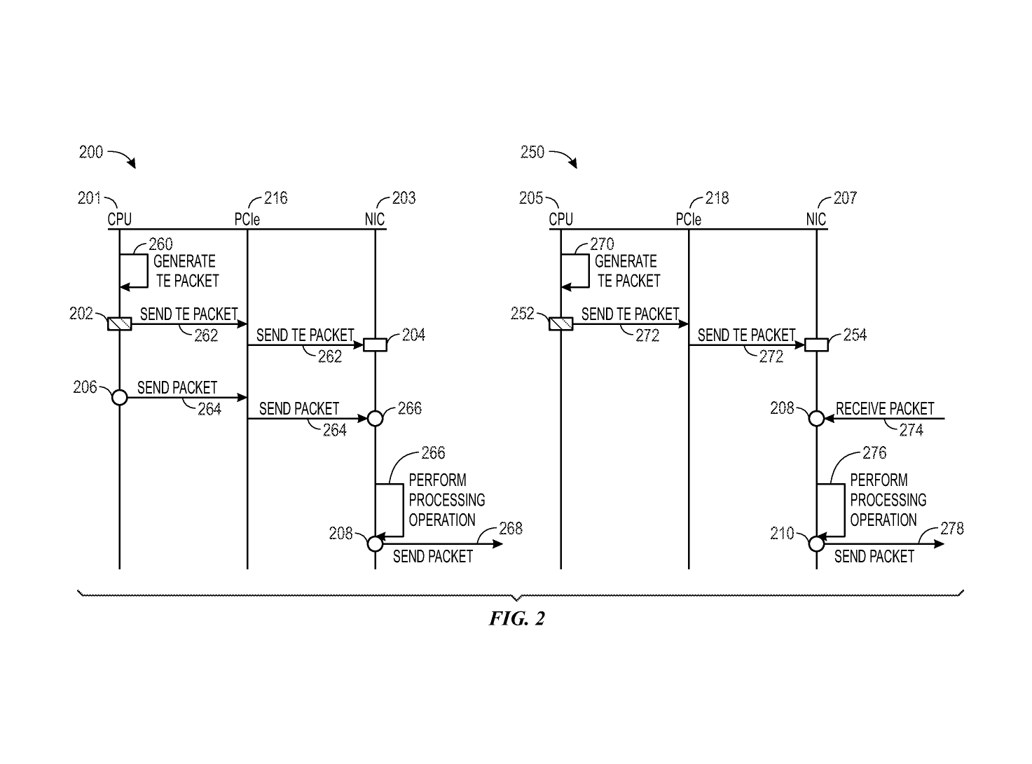

FIG. 2 is a diagram illustrating a first triggered operation 200 triggered by a processor 201 as a local processor and a second triggered operation 250 triggered by a remote processor. As used herein, a triggered operation, network-triggered operation, or network-offloaded triggered operation may include a networking operation that is performed once a threshold associated the networking operation is met by a count associated with the networking operation. The processor 201 may represent the processor 106B of FIG. 1, for instance. Additionally, the triggered operation 200 and the triggered operation 250 may occur in any order or simultaneously. An example sequence of events is described for ease of description. The network interconnect device 203 (e.g., network interconnect devices 108 and/or 110) may implement triggered operations that in, some cases, may be chained to form a sequence of triggered operations. By doing so, overall latency of the operations may be reduced relative to host processor-based network operations. Although described herein as the first triggered operation 200 involving the processor 201 and a network interconnect device 203 and the second triggered operation 250 involving the processor 205 and the network interconnect device 207, it should be understood that the first triggered operation 200 and the second triggered operation 250 are examples for illustrative purposes and any suitable combination of operations triggered may be performed among various combinations of processors 104 and/or 106 and network interconnect devices 108 and/or 110 of FIG. 1.

As part of the first triggered operation 200, the processor 201 may generate 260 a triggered entry packet 202. The triggered entry (TE) packet 202 may include information associated with a processing operation, such as an indication of a processing operation to be performed by the network interconnect device 203 and an indication of a trigger threshold. The trigger threshold may be based on, for example, a number of processors that are associated with the processor 201 as child nodes or parent nodes of the processor 201. The processor 201 may send 262 the TE packet 202 to the network interconnect device 203 via a PCIe connection 216, and the network interconnect device 203 may store the TE packet 202 as a triggered list entry (TLE) 204 in a memory or register of the network interconnect device 203. The PCIe connection 216 may represent, for example, a PCIe connection of the inter-node interconnect 116 of FIG. 1.

The network interconnect device 203 may include a counter that may be used to maintain a count. The count may be updated by the network interconnect device 203 based on various received signals. For example, as part of operation of the system 200, the network interconnect device 203 may receive a direct communication (e.g., signal and/or packet) from the processor 201 to update the count. In response, the network interconnect device 203 may access a register associated with the counter to increment, decrement, or reset the count. The count may also be updated based on the completion of a networking operation performed by the network interconnect device 203 (e.g., in response to an acknowledgment signal from the processor 201). The count may also be updated based on the completion of a remote networking operation. For example, the network interconnect device 203 may update the count based on receiving an acknowledgement signal associated with a remote networking operation from another network interconnect device. The network interconnect device 203 may also update the count based on an incoming packet addressing a memory location of the processor 201 that is associated with the counter (e.g., based on a mapping of host processor memory to the counter). Further, based on the count meeting or crossing the threshold indicated by the TLE 204, the network interconnect device 203 may perform the processing operation indicated by the TLE 204.

In the illustrated first triggered operation 200, the threshold indicated by the TLE 204 may be 1 (e.g., as low as a single increment). In other words, the network interconnect device 203 may perform the processing operation indicated by the TLE 204 based on direct communication from the processor 201, an acknowledgement signal resulting from a local networking operation, or an acknowledgment signal resulting from a remote networking operation and received from another network interconnect device. In the illustrated example, the processor 201 increments the count by sending 264 a packet 206 via the PCIe connection 216 to cause the network interconnect device 203 to increment the count. When the network interconnect device 203 receives the packet 206, the network interconnect device 203 may perform the processing operation 266. As part of performing the processing operation 266, the network interconnect device 203 may send 268 a packet 208 to a processor 104 and/or 106 via inter-node interconnect 118 and the network switch 112.

Referring now to the second triggered operation 250, the processor 205 may generate 270 a triggered entry packet 252. The TE packet 252 may include an indication of a processing operation to be performed by the network interconnect device 207 and an indication of a trigger threshold associated with the processing operation. For instance, the TE packet 252 may indicate data movement operation or other networking operation and a threshold number of increments after which the network interconnect device 207 may trigger the operation. The processor 205 may send 272 the TE packet 252 to the network interconnect device 207 via a PCIe connection 218, and the network interconnect device 207 may store the TE packet 252 as a triggered list entry (TLE) 254 in TLE memory.

The network interconnect device 207 may include a counter that maintains a count. Further, the count may be incremented by the network interconnect device 207 based on direct updates to the count from the processor 205, acknowledgement signals resulting from networking operations performed by other networking interconnect devices, or by updates to a memory location of the network interconnect device 207 associated with the processor 205. The network interconnect device 207 may compare the count to the threshold indicated by the TLE 254 and may determine, based on the comparison, whether the count is greater than or equal to the threshold. The network interconnect device 207 may perform the processing operation indicated by the TLE 254 based on the determination that the count is greater than or equal to the threshold.

As with the TLE 204, the trigger threshold associated with the TLE 254 may be as low as a single increment, such that a single increment to the counter may cause the network interconnect device 207 to perform the processing operation of the TLE 254. In the second triggered operation 250, however, the increment may not result from a signal received directly from the processor 205. Instead, a signal 208 may be received 274 from another network interconnect device, such as from the network interconnect device 110B via the network switch 112, referring to FIG. 1.

Of note, the signal 208 may result from the performance of the processing operation of a remote operation, such as the first triggered operation 200, initiated by a remote processor (e.g., processor 201) remote from the network interconnect device performing the operation. The signal 208 may include an acknowledgement signal of the first triggered operation 200, for instance. As such, processing operations indicated by TE packets and stored as TLEs may be triggered by a remote process. Further, performance of a processing operation by a network interconnect device may trigger processing operations of other remote processes, creating a chain of triggered operations. As illustrated, by performing 276 the processing operation of the second triggered operation 250, the network interconnect device may send 278 an additional signal 210 to another network interconnect device, which may trigger another processing operation, and so on.

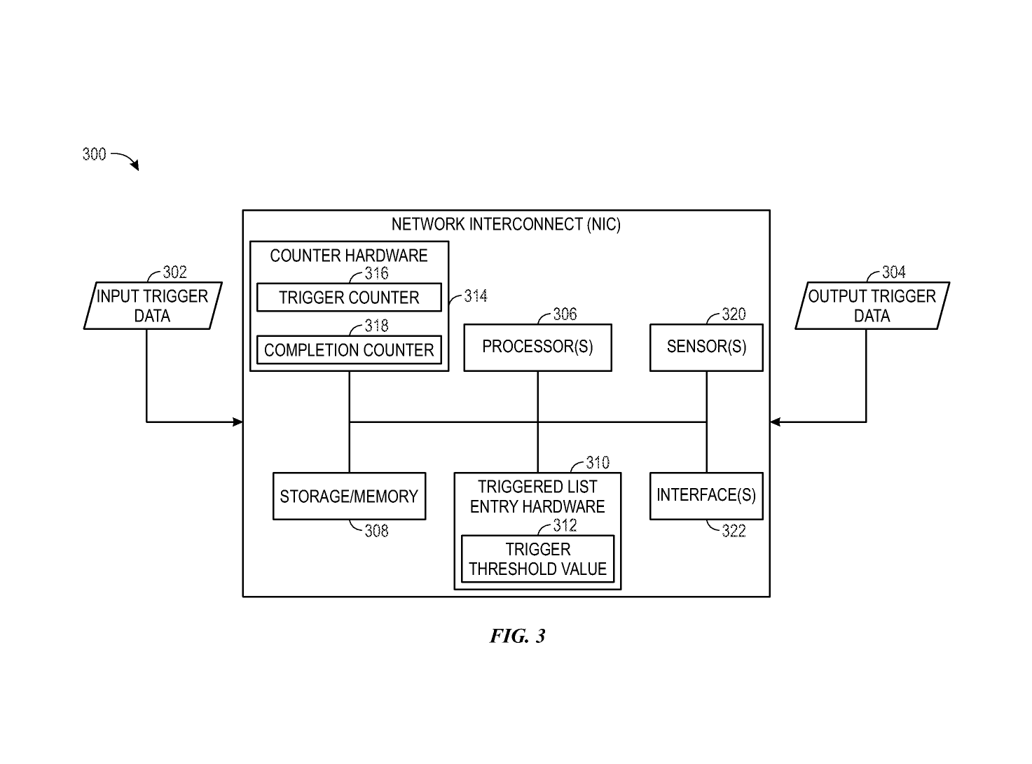

FIG. 3 is a diagram of a network interconnect device 300 that manages triggered operations. The network interconnect device 300 may include any suitable computing device that may utilize data memory and/or storage, such as a server, a desktop computer, a laptop computer, a tablet computer, a cellular device, a wearable devices, and/or other computing device. The network interconnect device 300 may represent any one of the network interconnect devices 108 of the system 100 of FIG. 1.

The network interconnect device 300 may receive input trigger data 302. The input trigger data 302 may include signals and/or packets that cause the network interconnect device to update a count, such as signals and/or packets received directly from a processor (e.g., via a PCIe connection). The input trigger data 302 may also include signals and/or packets received from other network interconnect devices 108 and 110, such as acknowledgement signals and/or packets of other networking operations that may be sent via the inter-node interconnect 118.

The network interconnect device 300 may send output trigger data 304 to other network interconnect devices 108 and 110 via the inter-node interconnect 118. The network interconnect device 300 may manage triggered operations associated with more than one processor of the processors 104 and/or 106. This offloaded management may enable the processors 104 and/or 106 to continue with other operations as opposed to waiting for acknowledge signals of a linear barrier operation.

The network interconnect device 300 may receive the input trigger data 302 from any of multiple processors (e.g., the processors 104 and/or 106). The network interconnect device 300 may generate and use the output trigger data 304. In some cases, the output trigger data 304 may not be sent to other network interconnect devices. The network interconnect device 300 may also generate the output trigger data 304 based on internally generated input trigger data 302. For example, the network interconnect device 300 may receive input trigger data 302 generated by the processor 306 and generate the output trigger data 304, which may be transmitted to one or more processors of the processors 104 and/or 106.

The storage/memory 308 may include any suitable articles of manufacture suitable for storing data and/or executable instructions (e.g., computer-readable instructions). The storage/memory 308 may include a storage device, such as a Non-Volatile Memory Express (NVMe) device, a hard disk drive (HDD), a solid-state drive (SSD), an optical drive, another type of storage device, flash memory, read-only memory (ROM), or any combination thereof. The storage/memory 308 includes memory that may include any suitable memory devices, such as a double data rate type 5 (DDR5) synchronous dynamic random-access memory (SDRAM), double data rate type 4 (DDR4) SDRAM, low-power double data rate (LPDDR) SDRAM, another suitable type of memory device, or any combination thereof.

The network interconnect device 300 also includes one or more processors 306. The one or more processors 306 may include one or more processing resources, such as a central processing unit (CPU), a graphics processing unit (GPU), implemented using a field programmable gate array (FPGA), or a combination thereof.

The one or more processors 306 may be operably coupled with the storage/memory 308 to facilitate the use of the one or more processors 306 to implement various stored programs. Such programs or instructions executed by the one or more processors 306 may be stored in any suitable article of manufacture that includes one or more non-transitory and computer-readable media at least collectively storing the instructions or routines, such as the storage/memory 308. For example, the processor(s) 306 may execute instructions stored in the storage/memory 308 to receive a TE from a processor 104 and/or 106 and store the TE as a TLE in triggered list entry (TLE) hardware 310, to update a count, to generate the output trigger data 304, and to output the output trigger data 304 based on a count reaching crossing a threshold indicated by a TLE. The processors 306 may also execute instructions stored in the storage/memory 308 to perform a processing operation or to instruct a processor 104 and/or 106 to perform the processing operation.

The TLE hardware 310 may include hardware components capable of storing information associated with processing operations for the processors 104 and/or 106, such as memory, registers, and/or buffers. For example, the TLE hardware 310 may store a respective TLE mapped to each processing operation associated with a processor 104 and/or 106 and managed by the network interconnect device 300. Each TLE may include a triggered descriptor including various information used by the network interconnect device 300 to perform the processing operation. For a remote direct memory access (RDMA) remote write operation, for instance, the triggered descriptor may include information regarding a source buffer, a target buffer, sizes of transfer buffers, memory registration, and target process details. The TLE hardware 310 may include, for example, memory, registers, buffers, and/or other suitable hardware for storing information associated with processing operations for the processors 104 and/or 106. Additionally, in some examples, the TLE hardware 310 may be part of or used in conjunction with the storage/memory 308.

The network interconnect device 300 may use received TEs and TLEs of the TLE hardware 310 for processing operations that include triggered operations (e.g., deferred execution operations). It should be noted that the network interconnect device 300 may also manage (e.g., simultaneously manage, at least partially at an overlapping time) processing operations that are not triggered operations and/or deferred execution operations and are instead immediate processing operations. For such immediate processing operations, the network interconnect device 300 may not utilize one or more of the input trigger data 302, the TLE hardware 310, and the counter hardware 314.

Each TLE stored in the TLE hardware may also include a trigger threshold value 312, also referred to herein as a threshold or trigger threshold, for a processing operation managed by the network interconnect device 300. Further, each TLE may be associated with address information or other identifier, such that the network interconnect device 300 may associate received data packets with the TLE based on the data packets addressing the TLE.

As illustrated, the network interconnect device 300 may also include counter hardware 314, which may include circuitry, such as flip-flop-based counters, capable of maintaining counts associated with triggered processing operation managed by the network interconnect device 300. The counts maintained by the counter hardware 314 may be associated with a processing operation based on a mapping included with the TLE in the TLE hardware 310. For example, a TLE may map a processing operation to a trigger counter 316 of the counter hardware 314. The trigger counter 316 may be incremented by the processor 306 based on receiving a data packet associated with the TLE. The TLE may also map a processing operation to a completion counter 318 of the counter hardware 314, which may maintain information related to the completion of the processing operation or other processing operation. While the trigger counter 316 and the completion counter 318 are shown for illustrative purposes, the counter hardware 314 may maintain additional counts associated with a processing operation, and a TLE stored in the TLE hardware 310 may map a processing operation to the additional counts.

The network interconnect device 300 also includes one or more interfaces 322 that enable other remote devices and/or a user to interact with the network interconnect device 300. The one or more interfaces 322 may include, for example, one or more network interfaces for a personal area network (PAN), such as a Bluetooth network, for a local area network (LAN) or wireless local area network (WLAN), such as an IEEE 802.11x Wi-Fi network, an IEEE 802.15.4 wireless network, an Ethernet network, and/or for a wide area network (WAN), such as a cellular network. The interface(s) 322 may include, for example, Ethernet I/O ports to receive and transmit data packets to and from the network switches 112 and/or 114 via the inter-node interconnect 118.

The interface(s) 322 may also include PCIe ports to receive data packets from the processors 104 and/or 106 and transmit data packets to the processors 104 and/or 106. The one or more interfaces 322 may additionally or alternatively include one or more interfaces for, for example, broadband fixed wireless access networks (WiMAX), mobile broadband Wireless networks (mobile WiMAX), and so forth. The one or more interfaces 322, in combination with a display, may enable a user to control the network interconnect device 300. For example, the one or more interfaces 322 may enable a remote device or a user to control operation of one or more components of the network interconnect device 300. The one or more interfaces 322 may have an input-output (IO) interface, such as a Universal Serial Bus (USB) interface, a coaxial cable interface, or a combination thereof. The one or more interfaces 322 may enable connection of a keyboard and/or mouse, a microphone that may obtain a user’s voice for various voice-related features, and/or a speaker that may enable audio playback.

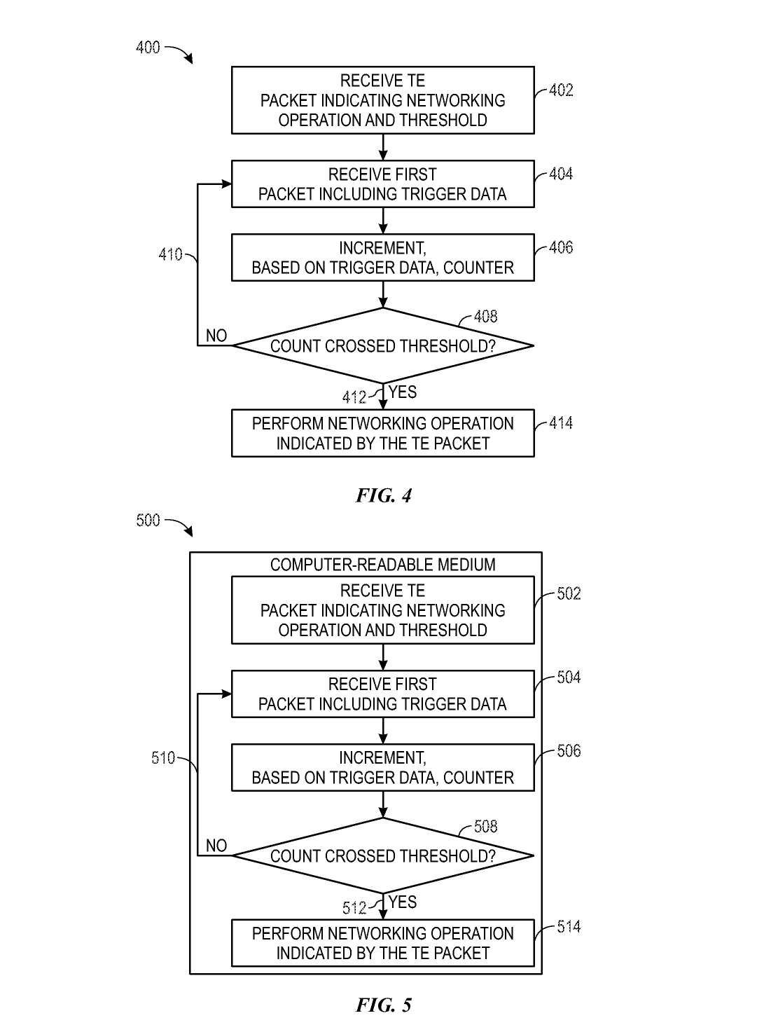

FIG. 4 is a flow diagram of a process 400 for implementing triggered operations that may be implemented using one or more processors (e.g., the processor(s) 306) and/or another processing resource of the network interconnect device 300. The process 400 includes the one or more processors and/or another processing resource receiving a triggered entry (TE) packet indicating a networking operation and a threshold (block 402). The TE packet may be received from a processor of the processors 104 and/or 106 via the one or more interfaces 322, for instance.

The networking operation may include any task that may be offloaded from a processor the network interconnect device 300. The networking operation may include any suitable processing operation or computing operation such as a data transfer operation to be performed by the network interconnect device 300, a processing operation to be performed by the network interconnect device 300 or by a processor of the processors 104 and/or 106, or the like. Networking operations may also include memory moves, copies, writes, reads, computations (e.g., dot product computations, multiplies, accumulates, etc.), or other operations that may be offloaded to the network interconnect device. In some cases, a networking operation may be determined by a processor based on a networking structure that may be determined by the processor and stored in a compute blade of the processor. The TE packet may also include a triggered descriptor including various information to perform the networking operation. For a remote direct memory access (RDMA) remote write operation, for instance, the triggered descriptor may include information regarding a source buffer, a target buffer, sizes of transfer buffers, memory registration, and target process details. The threshold may indicate a value that, when crossed by a count associated with the networking operation, may cause the network interconnect device 300 to perform the networking operation.

The one or more processors 306 and/or another processing resource of the network interconnect device 300 also receives a first packet that includes trigger data (block 404). The trigger data may be received from, for example, a processor of the processors 104 and/or 106 (e.g., a local processor) via a PCIe connection of the inter-node interconnect 118 to locally trigger a networking or processing operation. The trigger data may additionally or alternatively be received from another network interconnect device via the inter-node interconnect 118 and the network switch 112 and/or 114 as a remotely triggered operation. The trigger data may include an address or other indication of a counter of the network interconnect device 300.

The one or more processors 306 and/or another processing resource of the network interconnect device 300 increments the counter based on the trigger data (block 406). The network interconnect device 300 may determine that the first packet and/or the trigger data is associated with the counter. For example, the trigger data may include an address within a memory location registered for counter within the network interconnect device 300. In response, the one or more processors 306 and/or another processing resource of the network interconnect device 300 may increment the counter. The one or more processors 306 and/or another processing resource of the network interconnect device 300 may increment the counter by, for example, instructing the counter hardware 314 to increment the trigger counter 316 associated with the counter.

The one or more processors 306 and/or another processing resource of the network interconnect device 300 may determine whether the count has crossed the threshold indicated by the TE packet (block 408). If the count has not crossed the threshold (410), the one or more processors 306 and/or another processing resource of the network interconnect device 300 may continue to receive an additional packet including trigger data (block 404). If, however, the count has crossed the threshold (412), the one or more processors 306 and/or another processing resource of the network interconnect device 300 may perform the networking operation indicated by the TE packet (block 414). In some systems, the network interconnect device 300 may perform a processing operation by sending a packet 208 or other suitable signal to a processor 104 and/or 106 to have the processor 104 and/or 106 begin performing the processing operation.

FIG. 5 is a flow diagram illustrating a computer-readable medium 500 for implementing the triggered operations of FIG. 4. The computer-readable medium 500 may store instructions that are executed using the one or more processors 306 and/or another processing resource of the network interconnect device 300. The computer-readable medium 500 is non-transitory. The instructions may be implemented using one or more processors 306 and/or another processing resource of the network interconnect device 300. The stored instructions in the computer-readable medium 500 may be part of the storage/memory 308 and/or any other software. The stored instructions may be used to receive a triggered entry (TE) packet indicating a networking operation and a threshold (block 502). The TE packet may be received from a processor of the processors 104 and/or 106 via a PCIe connection of the inter-node interconnect 118 and the one or more interfaces 322, for instance.

The networking operation may include any task that may be offloaded from a processor the network interconnect device 300. The networking operation may include any suitable processing operation or computing operation such as a data transfer operation to be performed by the network interconnect device 300, a processing operation to be performed by the network interconnect device 300 or by a processor of the processors 104 and/or 106, or the like. Networking operations may also include memory moves, copies, writes, reads, computations (e.g., dot product computations, multiplies, accumulates, etc.), or other operations that may be offloaded to the network interconnect device. In some cases, a networking operation may be determined by a processor based on a networking structure that may be determined by the processor and stored in a compute blade of the processor. The TE packet may also include a triggered descriptor including various information to perform the networking operation. For a remote direct memory access (RDMA) remote write operation, for instance, the triggered descriptor may include information regarding a source buffer, a target buffer, sizes of transfer buffers, memory registration, and target process details. The threshold may indicate a value that, when crossed by a count associated with the networking operation, may cause the network interconnect device 300 to perform the networking operation.

The instructions cause the one or more processors 306 and/or another processing resource of the network interconnect device 300 to receive a first packet that includes trigger data (block 504). The trigger data may be received from, for example, a processor of the processors 104 and/or 106 (e.g., a local processor) via a PCIe connection of the inter-node interconnect 118 to locally trigger a networking or processing operation. The trigger data may also be received from another network interconnect device via the inter-node interconnect 118 and the network switch 112 and/or 114 to remotely trigger a networking operation. The trigger data may include an address or other indication of a counter associated with a networking operation.

The instructions cause the one or more processors 306 and/or another processing resource of the network interconnect device 300 to increment a counter based on the trigger data (block 506). The network interconnect device 300 may determine that the first packet and/or the trigger data is associated with the local processor. For example, the trigger data may include an address within a memory location registered for the counter within the network interconnect device 300. In response, the instructions may cause the one or more processors 306 and/or another processing resource of the network interconnect device 300 to increment the counter. The instructions may cause the one or more processors 306 and/or another processing resource of the network interconnect device 300 to increment the counter by, for example, instructing the counter hardware 314 to increment the trigger counter 316 associated with the counter.

The instructions cause the one or more processors 306 and/or another processing resource of the network interconnect device 300 to determine whether the count has crossed the threshold indicated by the TE packet (block 508). If the count has not crossed the threshold (510), the instructions cause the one or more processors 306 and/or another processing resource of the network interconnect device 300 to continue to receive an additional packet including trigger data (block 504). If, however, the count has crossed the threshold (512), the instructions cause the one or more processors 306 and/or another processing resource of the network interconnect device 300 to perform the networking operation indicated by the TE packet (block 514). In some systems, the network interconnect device 300 may cause a processing operation to occur through sending a packet 208 or other suitable signal to a processor 104 and/or 106, where causing the processing operation to occur could include instructing the processor 104 and/or 106 to begin performing the processing operation, to read instructions that cause the performance of the processing operation from memory, or the like.

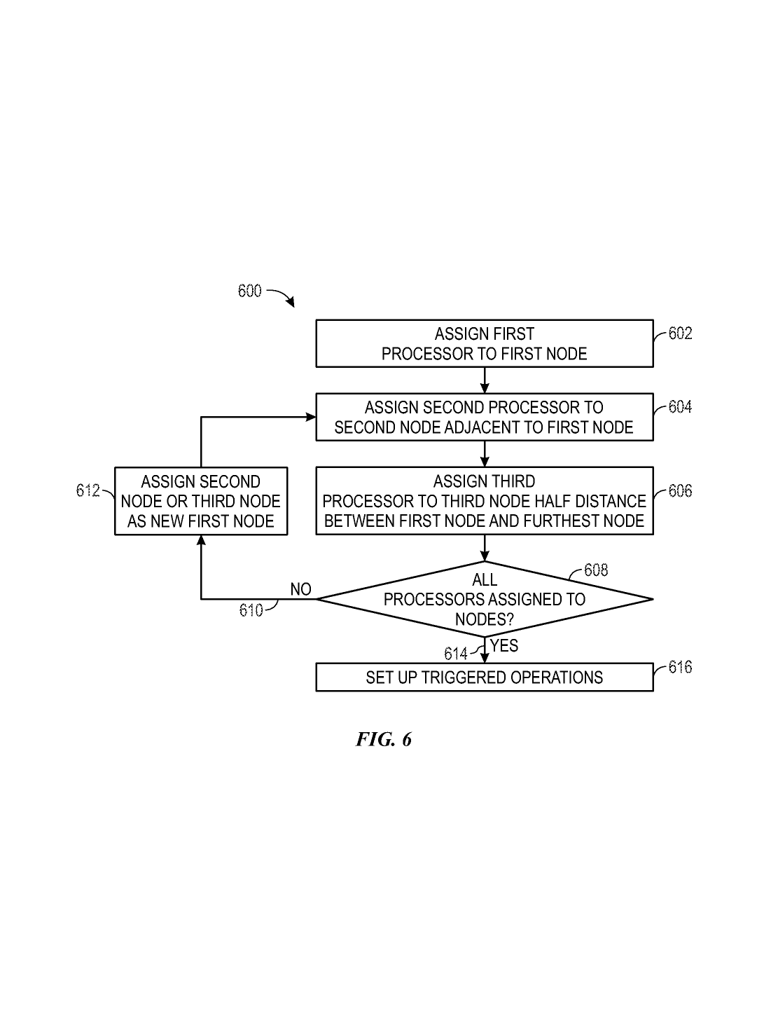

FIG. 6 is a flow diagram of a process 600 for determining a networking structure that may be used with the triggered operations that may be implemented using one or more processors. For instance, the one or more processors may include the one or more processors 104 and/or 106, processors 306, and/or another processing resource of the compute blades 102 of the system 100 of FIG. 1. The process may include using the one or more processors to determine a networking structure of a system (e.g., the system 100). The networking structure may include multiple nodes, each node respectively associated with one or more networking operations or processing operations of the one or more processors. The process 600 may be performed by any number of the one or more processors. An indication of the networking structure may be stored in a storage and/or memory of compute blades of the one or more processors. The networking structure may be used by the one or more processors to determine a processor (e.g., a target processor) to which a data packet or other signal is sent as part of a barrier operation. For example, the networking structure may be stored as a mapping or other correspondence in a compute blade, and a processor of the one or more processors may use the mapping when a networking operation is offloaded to a network interconnect device. The mapping may include entries for each processor that indicate a position of the node to which the processor is assigned (e.g., root, parent, child, leaf, etc.), along with indications of (e.g., pointers to) associated nodes and/or associated processors.

The process 600 includes assigning a first processor of processors (e.g., processors 104 and/or 106) to a first node (e.g., parent node) of the networking structure (block 602). For example, the networking structure may include an index for each processor. Further, the assignment of processors to nodes may include a relationship and/or hierarchy between the nodes. For example, the parent node assigned to in block 602 may be considered a root node of the networking structure, additional nodes may each be assigned as child nodes of the parent node, and as parent nodes of further additional nodes. Nodes without child nodes may be considered leaf nodes. Additionally, the root node may be referred to herein as a first node, the first child node may be referred to herein as a second node, and the second child node may be referred to herein as a third node. Assigning the first processor of the processors 104 and/or 106 to the parent node of the networking structure may include designating the first processor as a parent node in a mapping of the networking structure. For example, this may include updating an entry of the first processor in the networking structure to include an indication that the first processor is a parent node. As such, the one or more processors may assign a processor to a node, for example, updating the mapping of the networking structure stored in a storage or memory resource of a respective compute blade 102.

The one or more processors also assign a second processor of the one or more processors to a first child node of the parent node based on the second processor having an index numerically adjacent to (e.g., subsequent to, adjacent to, one more or less than) the index of the first processor (block 604). This may include assigning the second processor as a first child node of the parent node within the mapping of the networking structure. This may also include updating the entry of the first processor to include an indication of association (e.g., a pointer to) the first child node. The one or more processors may assign a third processor to a second child node based on the second processor being half a distance between the first processor and the farthest processor from the first processor (block 606) based on respective distances of each processor. The total distance may refer to physical distances, logical distances, temporal distances, or any suitable quantifiable distance indication between the one or more processors.

The one or more processors determine whether all of the one or more processors have been assigned to a node of the networking structure (block 608). If not all of the one or more processors have been assigned to nodes (610), the one or more processors may assign the second node or the third node as a new first node (block 612). The one or more processors may continue by assigning additional processors as child nodes of the new parent node in blocks 604 and 606 (e.g., such that the additional processors are assigned as grandchild nodes of the original parent node) As such, in some cases, the first child node and/or the second child node may be both a child node (e.g., of the previous parent node) and a parent node (e.g., of one or more grandchild nodes). If, however, all processors have been assigned to nodes of the networking structure (614), the one or more processors may set up triggered operations (block 616). For example, the one or more processors may perform the first triggered operation 200 of FIG. 2, including generating a TE packet.

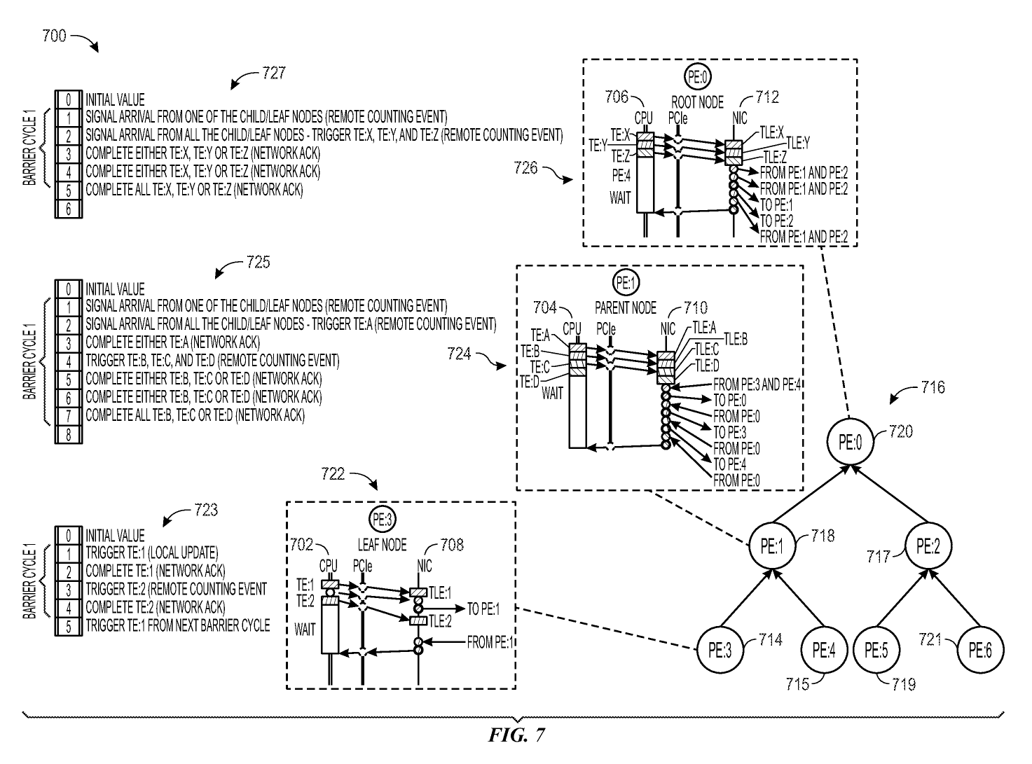

FIG. 7 is a diagram illustrating a triggered operation performed by processors and network interconnect devices of a networking structure, such as a network structure mapped using the process 600 of FIG. 6. The triggered operation 700, also referred to herein as a barrier process, barrier collective operation, or barrier networking process, may be performed by processors 702, 704, and 706 and the network interconnect devices 708, 710, and 712. While the network interconnect devices 708, 710, and 712 are described as three separate network interconnect devices for ease of description, in some examples, the functions of the network interconnect devices 708, 710, and 712 may be performed by a different number of network interconnect devices (e.g., one network interconnect device).

As illustrated, the processor 702 may be assigned to a leaf node 714 of a networking structure 716, the processor 704 may be assigned to a parent node 718 of the networking structure 716, and the processor 706 may be assigned to a root node 720 of the networking structure 716. The networking structure 716 may be determined by the processors 702, 704, and 706. For example, the networking structure may be mapped using the process 600 of FIG. 6.

Further, while the processes of the leaf node 714, the parent node 718, and the root node 720 are elaborated upon, the networking structure 716 may include other nodes to which other processors are assigned. The parent node 718 may be associated with an additional child node, here illustrated as a leaf node 715, a parent node 717 may be a child node of the root node 720, and leaf nodes 719 and 721 may be child nodes of the parent node 717.

The triggered operation 700 includes a process 722 initiated by the processor 702. The process 722 corresponds to updates 723 of a counter maintained by the network interconnect device 708 for the processor 702 (e.g., for networking operations indicated by TEs of the processor 702). In some examples, the process 722 may also be performed by processors corresponding to the leaf nodes 719 and 721 of the networking structure 716 in place of and/or concurrent to the processor 702 performing the process 722.

The processor 702 may initiate the process 722 by generating a first TE (TE:1) and a second TE (TE:2). The first TE may indicate a networking operation to send a signal (e.g., data or other signal) to the processor 704 of the parent node 718, and the second TE may indicate a networking operation to send an indication to the processor 702 that the triggered operation 700 is completed (e.g., an acknowledgement signal). In the illustrated example, the first TE may indicate a threshold of 1 to perform the networking operation each time a packet is received. The second TE may indicate a threshold of 3 bundling acknowledgements into groups of 3.

It should be noted that, in the illustrated example, the network interconnect device 708 maintains a common counter for the first TE and the second TE. When the counter is a common counter, the thresholds respectively indicated by the first and second TE may correspond to a threshold offset from a current count, such that as counts increase the processor 702 may differentiate between when the first TE is crossed and when the second TE is crossed through a same count of the common counter. The processor 702 may send the first TE to the network interconnect device 708 using a PCIe coupling, such as a PCIe connection of the inter-node interconnect 118 of FIG. 1. The processor 702 may send trigger data (e.g., a packet) associated with the first TE and, in response, the network interconnect device 708 may update a counter associated with the first TE and the second TE (e.g., by incrementing the counter by 1).

The network interconnect device 708 may compare the counter to the threshold indicated by the first TE and may determine, based on the comparison, whether the counter is greater than or equal to the threshold. Based on the determination that the counter is greater than or equal to the threshold, the network interconnect device 708 may perform the networking operation of the first TE. Performing the networking operation of the first TE may include sending a signal (e.g., trigger data) to the processor 704 of the parent node 718. By performing the networking operation of the first TE, the counter for the first TE and the second TE may be incremented by one. For example, the processor 704 may send an acknowledgement signal associated with the networking operation and, in response, the counter for the first TE and the second TE may be incremented by one.

The processor 702 may send the second TE to the network interconnect device 708. Afterwards, the network interconnect device 708 may receive a packet that includes trigger data indicating the first TE and/or the second TE from the processor 704 of the parent node 718. In response, the network interconnect device 708 may update the counter associated with the first TE and the second TE, crossing the threshold of the second TE. Based on the counter crossing the threshold of the second TE, the network interconnect device 708 may perform the networking operation of the second TE by sending a packet to the processor 702 indicative of completion of the triggered operation 700.

The triggered operation 700 also includes a process 724 that may be performed by the processor 704, associated with the parent node 718, and the network interconnect device 710. The process 724 corresponds to updates 725 of a counter maintained by the network interconnect device 710 for the processor 704. The process 724 may begin with the processor 704 generating four TEs (TE:A, TE:B, TE:C, and TE:D) and sending each of the four TEs to the network interconnect device 710 via a PCIe coupling between the processor 704 and the network interconnect device 710. While illustrated as four TEs, the number of TEs generated and sent by the processor 704 may vary based on the networking structure 716 and/or implementation. In an example, a processor corresponding to a parent node, such as the processor 704, may generate a TE for the root node 720, a TE for each child node of the parent node 718 (e.g., the leaf nodes 714 and 715), and a TE for the parent node 718 (e.g., for itself).

The thresholds indicated by the four TEs generated by the processor 704 may also be based on the networking structure 716. For example, the threshold indicated by the TE:A may be equal to the number of child nodes of the parent node 718 which, in the illustrated example, is 2 (the leaf node 714 and the leaf node 715). The networking operation indicated by the TE:A may include sending a packet to the processor 706 of the root node 720. As such, when packets from each leaf node 714 and 715 of the parent node 718 are received at the network interconnect device 710, the count of the TE:A may reach the threshold of 2, and the network interconnect device 710 may send a packet to the network interconnect device 712. That is, the network interconnect device 710 may wait to send the packet to the root node 720 until packets have been received from each child node of the parent node 718 (e.g., the leaf nodes 714 and 715).

The networking operation indicated by the TE:B and the TE:C may include sending a data packet (e.g., an update message) to each leaf node 714 and 715 associated with the parent node 718. Further, the thresholds indicated by each of the TE:B and the TE:C may be determined as equal to two more than the number of child nodes associated with the parent node 718 (e.g., the number of leaf nodes 714 and 715), which is 4 in the illustrated example. This may allow the network interconnect device 710 of the parent node 718 to wait for a packet from the root node 720 to be received before completing the networking operations of TE:B and TE:C by sending a packet to each leaf node 714 and 715.

The networking operation indicated by the TE:D may include the network interconnect device 710 sending an acknowledgement to the processor 704that the triggered operation 700 has completed. In the illustrated example, the threshold indicated by the TE:D is set to 4. As such, when 4 packets have been received and the counter has been incremented 4 times, the network interconnect device 710 may perform the networking operation of the TE:D by sending a packet to the processor 704 indicative of completion of the triggered operation 700.

The triggered operation 700 also includes a process 726 that may be performed by the processor 706, associated with the root node 720, and the network interconnect device 712. The process 724 corresponds to updates 727 of a counter maintained by the network interconnect device 712 for the processor 706. The process 726 may begin with the processor 706 generating three TEs (TE:X, TE:Y, and TE:Z) and sending each of the three TEs to the network interconnect device 712 via a PCIe coupling between the processor 706 and the network interconnect device 712. While illustrated as three TEs, the number of TEs generated and sent by the processor 706 may vary based on the networking structure 716 and/or for different implementations. In an example, a processor corresponding to a parent node, such as the processor 706, may generate a number of TEs equal to one more than a number of child nodes of the root node 720 (e.g., the number of the parent nodes 717 and 718). The networking operations indicated by the TE:X and TE:Y may include sending respective packets to the parent nodes 717 and 718. The networking operation indicated by the TE:Z may include the network interconnect device 712 sending an acknowledgement to the processor 706 that the triggered operation 700 is complete.

In the illustrated example, the thresholds indicated by the TE:X, TE:Y, and TE:Z may each be 2, and may be determined based on the number of child nodes associated with the root node 720 (e.g., the parent nodes 717 and 718). This may allow the root node 720 to wait for the arrival of packets from each child node associated with the root node 720 (e.g., the parent nodes 717 and 718) before performing the networking operation indicated by each of the TE:X, TE:Y, and TE:Z (e.g., sending packets to the network interconnects of each parent node 717 and 718 and to the processor 706).

As described here, PCIe couplings are used between compute nodes and CPU/GPUs of respective compute notes. It should be understood that PCIe may correspond to a serial data communications. Descriptions used herein may similarly apply to PCI couplings, which may correspond to parallel data communications. Furthermore, in some systems, couplings other than PCI or PCIe may be used. Descriptions used herein may similarly apply more broadly to any coupling between processors of a HPC system that introduce latency. By offloading triggered barrier management to processing circuitry of the coupling, some amount of coupling crossings may be reduced, enabling reduced latency within HPC systems using triggered barrier management.

Accordingly, the present disclosure generally relates to adapting triggered operations to be managed by a network interconnect. By offloading triggered operation management to the network interconnect, latency and computation costs of the triggered operations may reduce through reducing PCIe crossings that occur in association with such management. For example, by offloading trigger management from local processing circuitry of the compute blades to processing circuitry of a respective network interconnect used to intercouple the compute blades, the network interconnect may receive trigger condition data, confirm whether a condition is met, and initiate chained operations when the condition is met, reducing PCIe crossings, and thus overall system latencies. Further, while the present disclosure describes processes for performing triggered operations that are largely offloaded to a network interconnect device, such processes may be combined with or adapted other processes that may offload triggered operations to other devices, like a DPU. Examples of such techniques may include triggered operations performed as remote direct memory operations by data processing units (DPUs) in which triggered operations are initiated by active messages outside of target processes of a processing or networking operation.

While certain features of the present disclosure have been illustrated and described herein, many modifications and changes will occur to those skilled in the art. It is, therefore, to be understood that the appended claims are intended to cover all such modifications and changes as fall within the true spirit of the present disclosure.

One or more specific aspects of the present disclosure will be described below. In an effort to provide a concise description of these aspects, all features of an actual implementation may not be described in the specification. It should be appreciated that in the development of any such actual implementation, as in any engineering or design project, numerous implementation-specific decisions are made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various aspects of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

1. A system, comprising:
a first processor;
a network switch; and
a network interconnect device configured to couple between the first processor and the network switch, wherein the network interconnect device comprises:
a counter configured to maintain a count;
triggered list entry (TLE) memory configured to store an indication of a processing operation and an indication of a threshold; and
processing circuitry configured to:
receive, from the network switch, a first packet;
adjust, in response to receiving the first packet, the count;
determine that the count crosses the threshold; and
in response to determining that the count crosses the threshold stored in the TLE memory, perform the processing operation.

2. The system of claim 1, wherein the processing circuitry is configured to:
receive a triggered entry (TE) packet from the first processor, the TE packet comprising the indication of the processing operation and the indication of the threshold; and
store the TE packet in the TLE memory.

3. The system of claim 2, wherein adjusting, in response to receiving the first packet, the counter comprises:
determining that the first packet addresses a memory location associated with the counter; and
incrementing the counter in response to determining that the first packet addresses a memory location associated with the counter.

4. The system of claim 1, wherein the processing circuitry is configured to perform the processing operation comprising causing a triggered operation of a second network interconnect device.

5. The system of claim 1, wherein the first processor is configured to:
receive an indication of a networking structure, wherein the networking structure comprises a plurality of nodes respectively associated with one or more processing operations of a plurality of processors; and
assign, based on the networking structure, the first processor to a first node of the plurality of nodes.

6. The system of claim 5, wherein the first processor is configured to assign the first processor to the first node based on respective distances between the first processor and each other processor of the plurality of processors.

7. The system of claim 6, wherein the respective distances comprise one or more physical distances, one or more logical distances, one or more temporal distances, or any combination thereof.

8. The system of claim 5, wherein the first processor is configured to:
receive an indication that a second processor of the plurality of processors was assigned a second node of the plurality of nodes, the second node being adjacent in distance to the first node; and
receive an indication that a third processor of the plurality of processors was assigned to a third node of the plurality of nodes,
wherein:
the second node is a child of the first node, the second node being adjacent to the first node; and
the third node is a child of the first node, the third node half a distance between the first node and a farthest node from the first node.

9. The system of claim 1, wherein the processing circuitry is configured to perform the processing operation based on sending, via a Peripheral Component Interconnect Express (PCIe) connection between the network interconnect device and a first compute blade device, a second packet.

10. The system of claim 9, comprising the first compute blade device coupled, via one or more switch devices, to a plurality of compute blade devices, wherein the first compute blade device comprises:
a first processor coupled, via the PCIe connection, to the network interconnect device; and
a second processor coupled, via a second PCIe connection, to a second network interconnect device.

11. A method, comprising:
receiving, at a network interconnect device and from first processing circuitry, a triggered entry (TE) packet, the TE packet indicating a networking operation and a trigger threshold value;
receiving, at the network interconnect device, a first packet, the first packet comprising trigger data;
incrementing, based on the trigger data, a counter; and
in response to the counter crossing the trigger threshold value, performing the networking operation indicated by the TE packet.

12. The method of claim 11, comprising receiving, from the first processing circuitry, instructions to initiate execution of a barrier networking process.

13. The method of claim 11, receiving, via a Peripheral Component Interconnect Express (PCIe) connection to the first processing circuitry, instructions to initiate execution of a barrier networking process.

14. The method of claim 11, wherein causing performance of the networking operation comprises sending an acknowledgement signal to the first processing circuitry.

15. The method of claim 11, wherein the first packet addresses a memory location of the counter.

16. A non-transitory, computer-readable medium, comprising computer-readable instructions that, when executed by one or more processors of one or more computers, cause the one or more computers to:
receive, from first processing circuitry, a triggered entry (TE) packet, the TE packet indicating a networking operation and a trigger threshold value;
receive, from a network switch, a first packet;
increment, based on the first packet, a counter; and
in response to the counter crossing the trigger threshold value, perform the networking operation indicated by the TE packet.

17. The non-transitory, computer-readable medium of claim 16, comprising computer-readable instructions that, when executed by the one or more processors of the one or more computers, cause the one or more computers to:
receive, from the first processing circuitry, instructions to initiate execution of a barrier networking process.

18. The non-transitory, computer-readable medium of claim 17, wherein the instructions are received from the first processing circuitry via a Peripheral Component Interconnect Express (PCIe) connection to the first processing circuitry.

19. The non-transitory, computer-readable medium of claim 16, wherein performing the networking operation comprises sending an acknowledgement signal to the first processing circuitry.

20. The non-transitory, computer-readable medium of claim 16, wherein incrementing, based on the first packet, the counter comprises:
determining that the first packet is associated with a memory location mapped to the counter; and
incrementing the counter in response to determining that the first packet is associated with the memory location mapped to the counter.
